(19) United States
(12) Patent Application Publication
(10) Pub. No.: US 2025/0343372 A1
(43) Pub. Date: Nov. 6, 2025

(54) Electrical Plug Connector and Plug Connector Assembly

(71) Applicant: Rosenberger Hochfrequenztechnik GmbH & Co. KG, Fridolfing (DE)

(72) Inventors: Michael Endlmaier, Fridolfing (DE); Georg Lisowski, Fridolfing (DE)

(21) Appl. No.: 19/191,262

(22) Filed: Apr. 28, 2025

(30) Foreign Application Priority Data
May 2, 2024 (EP) 24 173 863.2

(51) Int. Cl. H01R 13/52; H01R 12/71; H01R 13/502

(52) U.S. Cl. CPC H01R 13/5202; H01R 12/716; H01R 13/502

(57) ABSTRACT

An electrical plug connector having a plastic part and a metal part, wherein one of the said parts is accommodated at least partially in the other part. A sealing region is formed between the plastic part and the metal part whereat the plastic part and the metal part are interconnected in a force-fitting fashion. One of the parts has in the sealing region a connecting groove which runs around the whole of the periphery and can be accessed in an axial direction (x), and wherein the other part has, in the sealing region, a connecting rib which runs around the whole of the periphery and is accommodated in the connecting groove. The connecting groove and the connecting rib together form a pressure contact, which runs around the whole of the periphery such that a passage (P) between the plastic part and the metal part is fluid-tightly sealed.

The invention relates to an electrical plug connector having a plastic part and a metal part, between which a sealing region is formed, according to the preamble to claim 1.

The invention moreover relates to a plug connector assembly.

Electrical plug connectors for a wide range of application and in a wide range of variants and forms are known in the prior art. Electrical plug connectors generally serve to transmit electrical power and/or data signals to corresponding mating plug connectors.

It is sometimes needed to provide a seal between individual components of a plug connector in order to prevent permanently and securely the penetration of moisture and impurities into the interior of the plug connector and/or from a connection interface of the plug connector to another connection interface of the plug connector. Particularly high demands are made on plug connectors and their sealing, for example in the automotive sector, in particular when the plug connectors are employed in the outer region of the vehicle.

A seal between plug connector components is frequently effected in the prior art with separate sealing elements, in particular with O-rings. Reference should be made here, by way of example, to U.S. Pat. No. 5,658,171 A. Alternatively, sealing coatings can also be used as proposed, for example, in U.S. Pat. No. 6,986,800 B2.

A further demand, in particular in the automotive industry, generally consists in it being necessary to be able to produce the plug connectors economically in high quantities. It is therefore often problematic to supply a plug connector with sealing properties because of the accompanying elevated cost of materials, production and fitting.

In view of the known prior art, the object of the present invention consists in supplying a plug connector with high sealing properties which can preferably be produced and fitted particularly simply and economically.

In view of the known prior art, the object of the present invention consists in supplying a plug connector assembly with high sealing properties which can preferably be produced and fitted particularly simply and economically.

The object is achieved for the electrical plug connector with the features described in claim 1 and for the plug connector assembly with the features described in claim 14.

The dependent claims and the features described below relate to advantageous embodiments and variants of the invention.

The electrical plug connector according to the invention has a plastic part and a metal part.

The plastic part and the metal part, which are so referred to below collectively as “parts”, can in principle be any desired plug connector components of the plug connector. Thus the plastic part can, for example, be contact carrier for holding at least one electrical contact element, be a housing part (for example, an inner housing or an outer housing of the plug connector), be a touch-protection element or a different (electrically insulating) plug connector component. The metal can, for example, be an electrical contact element (for example, an electrical internal conductor contact element or an electrical external conductor contact element) or a housing component (for example, an inner housing or outer housing of the plug connector) or a different (electrically conductive) plug connector component.

According to the invention, one of the said parts (i.e. the plastic part of the metal part) is accommodated at least partially in the in each case other part.

It can thus be provided that plastic part is accommodated at least partially in the metal part or is at least partially enclosed by the metal part, or vice versa. For this purpose, in each case one of the said parts can have a suitable receptacle (for example, a blind hole or a leadthrough such as, for example, a through bore) in which a longitudinal portion (in particular a cylindrical portion) of the in each case other part is accommodated.

It can be provided that the plastic part and the metal part are arranged concentrically or coaxially with each other, which however does not absolutely have to be the case depending on the geometry of the parts. The centres of gravity or longitudinal axes/centre axes of the parts can also diverge because within the scope of the invention essentially the only important thing is that one of the parts is arranged a least partially inside the other part.

According to the invention, a sealing region is formed between the plastic part and the metal part.

The sealing region can ensure that a passage between the plastic part and the metal part is sealed. This seal can preferably be fluidtight (i.e. in particular for the purpose of providing a seal against gases and/or liquids). In exceptional cases, however, a seal can also already be provided within the scope of the invention only against impurities such as, for example, dirt and dust particles.

It is provided according to the invention that the plastic part and the metal part are connected to each other directly in a force-fitting fashion in the sealing region. At least one of the said parts has in the sealing region a connecting groove which runs around the whole of the periphery and can be accessed in an axial direction, wherein the in each case other of the said parts has in the sealing region a connecting rib which runs around the whole of the periphery and is accommodated in the connecting groove. The said connecting rib forms at least one pressure contact, which runs around the whole of the periphery, with the said connecting groove such that a passage between the plastic part and the metal part is sealed by the pressure contact.

A sealing function can thus advantageously be integrated into the parts to be sealed. It is consequently possible to dispense with an additional sealing element such as, for example, an O-ring, as a result of which material can be saved when producing the plug connector and time saved during fitting. Spraying on a sealing coating is also not absolutely necessary within the scope of the invention. The proposed plug connector can thus be produced and fitted simply and cost-effectively.

In one embodiment of the invention, it can thus in particular be provided that no separate sealing element, in particular no O-ring, is arranged between the plastic part and the metal part.

It has been shown that a durable and mechanically robust seal can be provided in the manner proposed. The invention is therefore particularly advantageously suited for use with plug connectors outdoors or in highly mechanically and thermally stressed areas such as, for example, in the automotive sector (for example, for a plug connector for camera modules of a vehicle). A further advantageous field of use can concern, for example, communication plugs on a mobile phone tower.

In an advantageous embodiment of the invention, it can be provided that the connecting groove and the connecting rib are in each case formed on a connecting flange of the plastic part/metal part.

In a particularly advantageous development of the invention, it can be provided that each of the two parts has in each case one of the connecting grooves and in each case one of the connecting ribs, which is accommodated in the connecting groove of the in each case other part.

It can thus be provided that one of the two parts has a connecting sequence consisting of one of the connecting grooves and one of the connecting ribs, which is connected to a complementary connecting sequence consisting of one of the connecting ribs and one of the connecting grooves of the in each case other part.

The use of parts which have in each case a connecting groove and a connecting rib, or the said connecting sequence/complementary connecting sequence, can be particularly advantageous because in this case the passage between the plastic part and the metal part in the region to be sealed or in the sealing region can be extended compared with a minimalistic variant of the invention (in which a single connecting groove and a single connecting rib are distributed on both sides), which increases the options for sealing in the sealing region.

It can accordingly also be advantageous if at least one of the parts, where appropriate also both parts, has more than one connecting groove and/or more than one connecting rib, for example two connecting grooves, three connecting grooves, four connecting grooves and/or two connecting rigs, three connecting ribs, four connecting ribs or even more connecting grooves or connecting ribs. The connecting sequence/complementary connecting sequence can thus correspondingly have a plurality of connecting grooves and connecting ribs. A connecting sequence/complementary connecting sequence only of a plurality of connecting grooves or only of a plurality of connecting ribs can also be provided. However, connecting grooves and connecting ribs preferably alternate in each case within the connecting sequence/complementary connecting sequence. A plurality of connecting grooves/connecting ribs are, however, generally not absolutely necessary.

In a development of the invention, it can in particular be provided that the connecting groove directly adjoins the connecting rib within the connecting sequence or the complementary connecting sequence.

Although preferred, this is not absolutely necessary. It can in principle also be provided that a connecting groove is spaced apart from the following connecting rib within the connecting sequence or the complementary connecting sequence.

According to a development of the invention, it can be provided that the pressure contact is designed so that it runs around the periphery at least along a line, preferably is designed so that it runs around the periphery over a plane surface.

The pressure contact can in particular be formed between directly opposite inner faces of side walls of the connecting grooves and outer faces of side walls of the connecting ribs by the said inner and outer faces bearing directly against each other over a plane surface or along a line. In order to provide a pressure contact along a line, for example, one of the said faces can be configured as convex or bulging, tapering, conical, cone-shaped or pointed or with another type of protuberance. A plane-surface pressure contact between the said inner and outer faces can be formed in particular between in each case predominantly plane surfaces but possibly also between complementarily arched faces. A plane-surface pressure contact can where appropriate also result only by virtue of the reciprocal deformation of the parts which is caused by the force fit.

In addition to the pressure contact or in addition to the force-fitting connection between the plastic part and the metal part, a form-fitting connection can optionally also be provided, for example reciprocal interlocking of the two parts (for example, interlocking of the connecting rib in the connecting groove or interlocking of the parts in a completely different portion).

The pressure contact is preferably designed so that it runs around the periphery within a plane, preferably within a surface oriented orthogonally to a longitudinal axis of the plug connector or the parts. The surface can, however, also be oriented obliquely to the longitudinal axis.

According to a development of the invention, it can be provided that a plurality of the said pressure contacts, preferably at least two pressure contacts, more preferably at least three pressure contacts, are distributed along the passage between the plastic part and the metal part or in the sealing region.

Any number of pressure contacts can in principle be arranged distributed along the passage or along the sealing region in order to further increase the sealing properties of the plug connector by redundancy. Lastly, a single pressure contact can, however, generally also be sufficient.

It can also be provided that a single pressure contact extends through the whole passage and thus seals the passage completely over a plane surface along its course.

In a development of the invention, it can be provided that the pressure contacts are arranged inside each other in a lateral direction with reference to the longitudinal axis of the plug connector. This means that at least one of the pressure contacts can be arranged inside a further pressure contact in a lateral direction relative to the longitudinal axis of the plug connector. The pressure contacts can, put simply, be “nested inside each other”.

The pressure contacts are preferably arranged inside each other concentrically, in particular in the case of pressure contacts running in a circle. In the case of a pressure contact running around the periphery in a circle, the diameters of the pressure contacts can therefore preferably all be different in order to arrange the pressure contacts inside each other.

Because the parts of the plug connector do not, however, absolutely have to be designed as round or circular, the concentric arrangement with the different diameters of the pressure contacts should be understood purely as an example.

It should be mentioned at this point that the definition that the pressure contacts are “arranged inside each other” does not exclude the pressure contacts being offset relative to each other in the longitudinal direction of the plug connector.

As an alternative or in addition to the use of a plurality contacts arranged inside each other, it can also be provided that a single pressure contact or a plurality of pressure contacts runs or run along a boundary surface with a serpentine or S-shaped profile in cross section.

In a development of the invention, it can be provided that in each case at least one of the pressure contacts is formed between all the inner faces or side walls, situated directly opposite one another, of the connecting grooves and the outer faces or side walls of the connecting ribs.

In this way, on the one hand the force-fitting connection between the plastic part and the metal part can be increased and on the other hand the sealing can also be improved.

In an advantageous development of the invention, it can be provided that a wall thickness of the connecting rib is widened, starting from its top face or starting from its free end.

It can moreover be provided that a width of the connecting groove is widened, starting from its groove base and/or narrows, starting from its front open end.

Narrowing/widening of the width of the connecting groove and/or the wall thickness of the connecting rib can simplify fitting and, for example, make it easier to insert the connecting rib into the connecting groove. The insertion force can moreover be increased gently during fitting.

It can be provided that the connecting rib has a rounded or bevelled axial end. A trapezoidal or pointed or conical end can also be provided.

In a development of the invention, it can be provided that the top face of the connecting rib forms an axial fitting end stop between the plastic part and the metal part.

In particular it can be provided that the top face of the connecting rib of one of the parts abuts the groove base of the connecting groove of the in each case other part in the completely fitted state of the two parts. Where a plurality of connecting grooves/connecting ribs are provided, a single fitting end stop can in principle already be sufficient. Lastly, a fitting end stop is, however, not absolutely necessary (or can also be provided at a different point of the parts or in the plug connector).

In an advantageous development of the invention, it can be provided that a longitudinal extent of the connecting rib is at least 0.3 mm, preferably at least 0.5 mm. Alternatively or additionally, it can moreover be provided that a wall thickness of the connecting rib is at least 0.1 mm, preferably at least 0.2 mm, more preferably at least 0.3 mm.

The extent of the depth or the longitudinal extent of the connecting groove and the width of the connecting groove can preferably be formed in a similar fashion to the abovementioned values such that the connecting rib can be inserted into the connecting groove with the best possible fit. In order to provide a particularly advantageous press fit, however, in particular the wall thickness of the connecting rib can be designed as slightly greater than the width of the connecting groove.

The longitudinal extent of the connecting rib or the depth of the connecting groove preferably runs in the longitudinal direction of the plug connector. The longitudinal extent of the connecting rib or connecting groove can, however, also be oblique or tilted with respect to the longitudinal axis of the plug connector, for example by a tilt angle of up to 45°, preferably up to 10°, more preferably up to 5°.

In an advantageous development of the invention, it can be provided that the plastic part is designed as a single piece.

The plastic part can be formed at least essentially from a single plastic material. The plastic element can in particular be produced as an injection-moulded or turned part. It is, however, not absolutely necessary that the plastic part is formed from a single plastic material. For example, a two-component technique can also be applied to form the plastic part. In this case, even one or more optional sealing lips can optionally be formed on the plastic part.

In an embodiment the invention, it can be provided that the metal part is formed from brass, in particular when the metal part is an electrical contact element such as, for example, the external conductor contact element mentioned below.

The metal part can optionally have a coating such as, for example, an Ni—Zn coating.

In an advantageous development of the invention, it can be provided that the plastic part has a hydrophobic surface (i.e. a water-repellent surface) and/or material properties that are resistant to hydrolysis (i.e. a material resistance to water).

In a development of the invention, it can be provided the he plastic part has a thermal coefficient of expansion which is less than 10·10⁻⁵ 1/K, preferably less than 20·10⁻⁵ 1/K.

In a development of the invention, it can moreover be provided that the plastic part has an elongation at break which is greater than 1%, preferably greater than 3%, particularly preferably greater than 5%.

In particular, it can be provided that the plastic part is formed from hard plastic (i.e. from a predominantly stiff plastic, in contrast to soft plastic or a predominantly elastic plastic).

The plastic part can particularly preferably comprise polyketone (PK) or polyether ether ketone (PEEK) or be formed from said plastics. However, further plastic materials can in principle also be suitable for producing the plastic part. The plastic part is, however, preferably not an elastomer.

In a development of the invention, it can be provided that the plastic part is accommodated at least partially in the metal part and is designed as a contact carrier for accommodating at least one internal conductor contact element, wherein the metal part is designed as an external conductor contact element.

This is a preferred embodiment of the invention. As already mentioned above, the configuration of the plastic part as a contact carrier and the configuration of the metal part as an external conductor contact, as well as the arrangement of the parts relative to each other, are however in principle only to be understood as an example. The features and advantages described above and below with respect to use of the invention to provide a sealing region between an external conductor contact element and a contact carrier can be transferred correspondingly also to other combinations of plug connector components which need to be sealed. As already mentioned above, it can for example also be provided that the metal part is an internal conductor contact element and the plastic part is its contact carrier, wherein the sealing region in this case can be formed, for example, between the internal conductor contact element and a contact chamber of the contact carrier. It can moreover also be provided that the plastic part is an insulating housing, wherein the sealing region can then be arranged between the insulating housing and an internal or external conductor contact element accommodated in the insulating housing. All the options mentioned are, however, to be understood only as examples and as not restrictive.

In an advantageous development of the invention, it can be provided that the plastic part and the metal part are jointly accommodated inside an outer housing.

The said outer housing can be, for example, an outer housing of the plug connector (an electrically insulating or an electrically conductive outer housing).

The outer housing can, however, also be an outer housing of a module connected only to the plug connector, in particular be the outer housing of an electrical module connected to the plug connector (referred to below also as a “module housing”). In this case, the plug connector can be formed, for example, as a housing plug connector of the module. Sealing of the housing interior of the module can then be enabled in a particularly advantageous manner by the proposed pressure contact.

In a development of the invention, it can be provided that the plug connector has a first connection interface for connecting the plug connector to a first module and a second connection interface for connecting the plug connector to a second module.

It can in particular be provided that a first end of the plastic part and a first end of the metal part are in each case oriented in the direction of the first connection interface, and a second end of the plastic part and a second end of the metal part are in each case oriented in the direction of the second connection interface. A seal between the first connection interface and the second connection interface can therefore advantageously be provided by the plug connector according to the invention.

As already mentioned, the plug connector according to the invention can be a plug connector of any plug connector type, i.e. for example a housing plug connector, a printed circuit board plug connector, or a cable plug connector. The invention is suitable for any variant of plug connectors, i.e. for example for coaxial plug connectors, differential plug connectors, plug connectors with a star quad formation, and plug connectors with differential and/or coaxial contact elements. Correspondingly, the invention can moreover also be suitable for use with plug connectors of any geometry (for example, round, oval, rectangular, or polygonal).

The plastic part and the metal part are preferably connected immovably to each other in their interconnected state, at least with respect to the forces to be expected within the scope of the intended use of the plug connector.

The invention also relates to a plug connector assembly having an electrical plug connector according to the explanation above and below, and an electrical module connected to the plug connector, or an electrical cable.

In a development of the invention, it can be provided that the module connected to the plug connector has a module housing with an interior to be sealed and a housing opening, leading into the interior, for connection to the plug connector.

The sealing region of the plug connector is preferably arranged between an end portion, facing the interior of the housing, of the plastic part and the metal part. Alternatively (less preferably), the seal or the sealing region can, however, also be arranged on that end portion of the part which is remote from the interior.

Where the plug connector assembly has an electrical cable connected to the plug connector, it can in particular be provided that the sealing region of the plug connector is arranged between a connection interface for connecting the plug connector to a corresponding mating plug connector and an interior, facing the cable, of the cable plug connector.

Features which have been described in connection with the plug connector can advantageously also be implemented for the plug connector assembly, and vice versa. Likewise, advantages which have been mentioned in connection with the plug connector can be understood as also relating to the plug connector assembly.

It should also be noted that terms such as “comprising”, “having” or “with” do not exclude other features or steps. Moreover, terms such as “a” or “the” which indicate a single step or feature do not exclude multiple features or steps, and vice versa.

In a puristic embodiment of the invention, it can, however, also be provided that the features introduced in the invention by the terms “comprising”, “having” or “with” are restricted. Accordingly, one or more enumerations of feature can be considered as restrictive within the scope of the invention, for example considered in each case for each claim. The invention can consist, for example, only of the features mentioned in claim 1.

It should be mentioned that descriptions such as “first” or “second” etc. are used predominantly for reasons of distinguishing between respective device or method features and are not necessarily intended to indicate that features are mutually dependent or are related to one another.

It should moreover be stressed that the values and parameters described in the present document include deviations or fluctuations of ±10% or less, preferably ±5% or less, more preferably ±1% or less, and very particularly preferably ±0.1% or less of the value or parameter mentioned in each case, provided that these deviations are not excluded in practice when the invention is implemented. The specification of ranges by start and end values also comprises all those values and fractions which are included by the range mentioned in each case, in particular the start and end values and a respective mean value.

Exemplary embodiments of the invention will be described below on the basis of the drawings.

The Figures show in each case preferred exemplary embodiments in which individual features of the present invention are illustrated in combination with one another. Features of an exemplary embodiment can also be implemented separately from the other features of the same exemplary embodiment and can accordingly be readily combined by a person skilled in the art to form further expedient combinations and sub-combinations with features of other exemplary embodiments.

Elements with the same function are provided with the same reference signs in the Figures.

In the drawings:

FIG. 1 shows schematically a plug connector assembly with an electrical plug connector according to a first exemplary embodiment of the invention and an electrical module in a view in section;

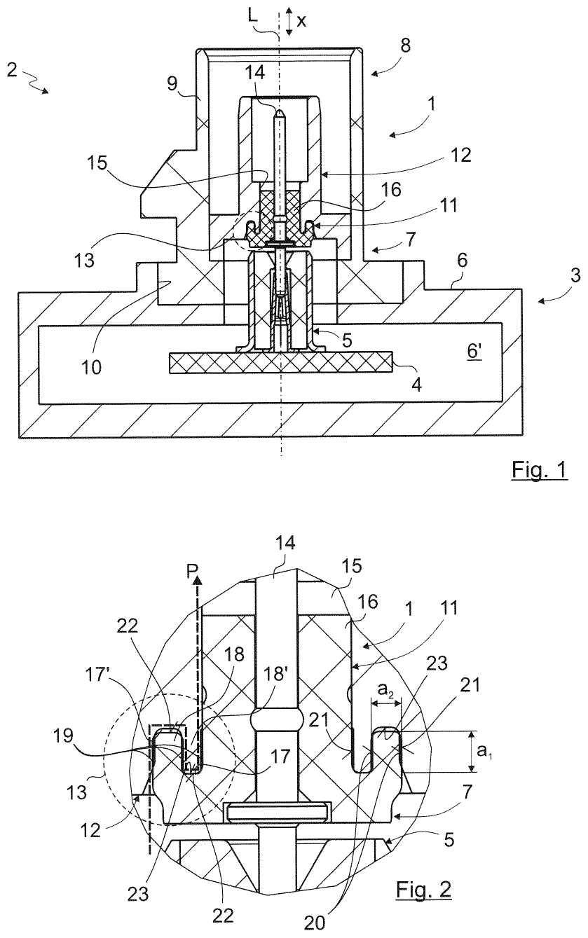

FIG. 2 shows schematically an enlarged detail of the plug connector of FIG. 1;

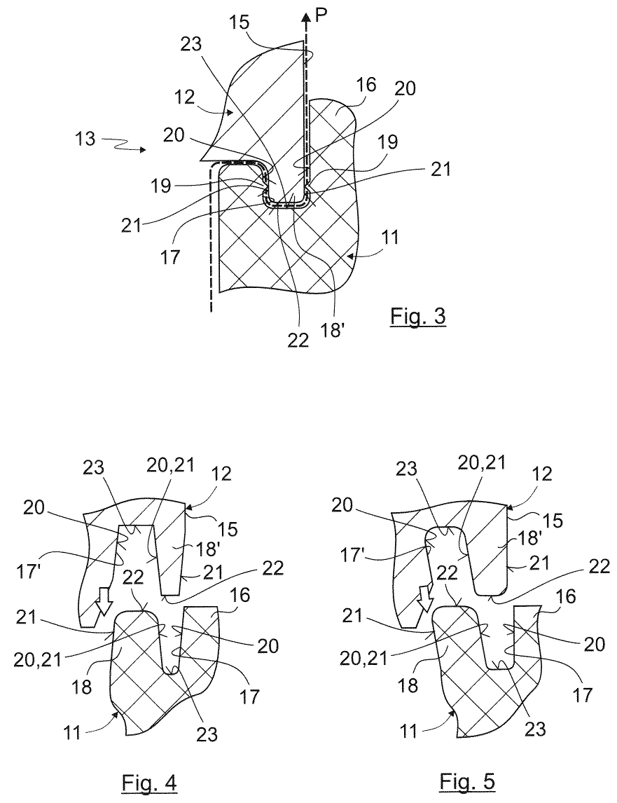

FIG. 3 shows schematically an enlarged detail of a sealing region of a plug connector according to a second exemplary embodiment of the invention;

FIG. 4 shows schematically an enlarged detail of a sealing region of a plug connector according to a third exemplary embodiment of the invention; and

FIG. 5 shows schematically an enlarged detail of a sealing region of a plug connector according to a fourth exemplary embodiment of the invention.

A first exemplary embodiment of a plug connector 1 according to the invention is illustrated in FIGS. 1 and 2 in a view in section, wherein FIG. 2 shows an enlarged detail from FIG. 1. The plug connector 1 is, for example, an electrical housing plug connector, which should, however, not be understood as limiting. The invention can in principle be suitable for any plug connector.

The electrical plug connector 1 illustrated in FIG. 1 is part of a plug connector assembly 2 consisting of the plug connector 1 itself and an electrical module 3. An electrical printed circuit board 4 with a printed circuit board plug connector 5 (a female connector in exemplary embodiment) is illustrated by way of example in the electrical module 3. The electrical printed circuit board 4 and the printed circuit board plug connector 5 of the electrical module 3 are accommodated in an interior 6′ to be sealed of the common module housing 6.

The printed circuit board plug connector 5 of the electrical module 3 electrically and mechanically connected to a first connection interface 7 of the plug connector 1. The plug connector 1 can be contacted, for example, by a corresponding mating plug connector (not illustrated) at a second connection interface 8 situated opposite the first connection interface 7 of the plug connector 1. An outer housing 9 of the plug connector 1 is connected module housing 6 of the electrical module 3 or plugged into a recess 10 in the module housing 6.

The plug connector 1 has a plastic part 11 and a metal part 12, between which sealing region 13 is formed at an end portion facing the interior 6′ in order to prevent fluids or dirt from penetrating from the second connection interface 8 into the interior 6′ of the electrical module 3.

In the exemplary embodiment, the plastic part 11 is accommodated in the metal part 12 and designed as a contact carrier 11 for accommodating an internal conductor contact element 14. The metal part 12 is formed by way of example as an external conductor contact element 12. The specific design of the plastic part 11 and the metal part 12, as well as the arrangement of the plastic part 11 inside the metal part 12, are, however, to be understood only as exemplary alternative embodiments of the invention. The plastic part 11 and the metal part 12 can in principle be any plug connector components of the plug connector 1. Moreover, the arrangement of the two parts 11, 12 relative to each other can also be swapped, wherein thus, for example, the metal part 12 can also be accommodated in the plastic part 11 (for example, a seal between an internal conductor contact element and the contact carrier can then be provided).

In order to a accommodate the plastic part 11 or the contact carrier, the metal part 12 or the external conductor contact element has a leadthrough 15 in which a cylindrical portion 16 of the contact carrier 11 is accommodated. A first end of the contact carrier 11 and a first end of the external conductor contact element 12 are associated in the exemplary embodiment in each case with the first connection interface 7, and a second end of the contact carrier 11 and a second end of the external conductor contact element 12 are associated with the second connection interface 8 of the plug connector 1 such that a passage P (cf FIG. 2) between the two parts 11, 12 and thus also between the connection interfaces 7, 8 is sealed.

The plastic part 11 or the contact carrier 11 and the metal part 12 or the external conductor contact element 12 are connected directly to each other in a force-fitting fashion in the sealing region 13. At least one of the said parts 11, 12 has in the sealing region 13 a connecting groove 17, 17′ which runs completely around the periphery and can be accessed in axial direction x (relative to the longitudinal axis L of the plug connector 1), wherein the in each case other of the said parts 11, 12 has in the sealing region 13 a connecting rib 18, 18′ which runs completely around the periphery and is accommodated in the connecting groove 17, 17′ (cf in each case in particular FIG. 2), and which forms at least one pressure contact 19, which runs completely around the periphery, with the connecting groove 17, 17′ in order to seal the passage P between the plastic part 11 and the metal part 12 by the pressure contact 19, preferably fluid-tightly. In order to be able to distinguish between them better, the connecting groove of the plastic part 11 is designated in the exemplary embodiments with the reference sign 17 and the connecting groove of the metal part 12 is designated with the reference sign 17′. Similarly, the connecting rib of the plastic part 11 is designated the reference sign 18 and the connecting rib of the metal part 12 is designated with the reference sign 18′.

In the exemplary embodiment of FIG. 1, a particularly preferred variant of the invention is illustrated in which each of the two parts 11, 12 has in each case one of the connecting grooves 17, 17′ and in each case one of the connecting ribs 18, 18′ which is accommodated in the connecting groove 17, 17′ of the in each case other part 12, 11. Each of the arts (11, 12) therefore has a connecting sequence consisting of a connecting groove 17, 17′ and a connecting rib 18, 18′ directly adjoining the connecting groove 17, 17′. A respective connecting rib 18, 18′ thus forms a corresponding side wall of the connecting groove 17, 17′ of the same part 11, 12. In this way, an S-shaped passage P can be formed in the sealing region 13, which can improve the sealing properties of the plug connector 1, in particular when a plurality of said pressure contacts 19 (three pressure contacts 19 in the exemplary embodiment) are distributed along the passage P between parts 11, 12. The pressure contacts 19 are preferably arranged inside one another, as illustrated (concentrically in the exemplary embodiment, although this does not necessarily have to be the case, depending on the geometry of the parts 11, 12).

It should be mentioned at this point that it can in principle also be provided that the parts 11, 12 have in each case a plurality of connecting grooves 17, 17′ and/or connecting ribs 18, 18′, as a result of which the corresponding portion of the passage P in the sealing region 13 can be lengthened further, i.e. starting from the S-shaped illustrated in FIGS. 1 and 2, for example, into a wave shape of any length.

It can in principle, however, also already be sufficient if only one of the two parts 11, 12 has a single connecting groove 17, 17′ and the in each case other part 12, 11 has only a single connecting rib 18, 18′, as illustrated in the second exemplary embodiment according to FIG. 3. Good sealing of the plug connector 1 can also be provided even in this minimalistic variant of the invention.

Where a plurality of pressure contacts 9 are formed in the sealing region 13, it can be provided that in each case at least one of the said pressure contacts 19 is formed on all the inner faces or side walls 20, situated directly opposite one another, of the connecting grooves 17, 17′ and the outer faces or side walls 21 of the connecting ribs 18, 18′, as can be seen in FIG. 2.

The pressure contacts 19 can be designed so that they run around the periphery over a plane surface, as indicated in FIGS. 1 and 2, or can alternatively also be designed so that they run around the periphery along a line, as illustrated in FIG. 3. Combinations of pressure contacts 19 which run around the periphery over a plane surface and along a line can thus also be provided in principle.

It is advantageously possible to dispense with additional sealing elements such as, for example, O-rings. The plastic part 11 can preferably be designed as a single piece and made at least essentially from a single plastic material. The plastic part 11 can here optionally have a hydrophobic surface but this is not absolutely necessary. It can be advantageous if the plastic part 11 has an elevated heat deflection temperature and/or a low shrinkage behavior and is formed from a hard plastic. Particularly advantageous materials are, for example, polyketone or polyether ether ketone.

The connecting ribs 18, 18′ (or at least one connecting rib 18, 18′) can optionally moreover advantageously be used as a fitting end stop between the parts 11, 12. As can be seen in FIG. 2, a top face 22 of a connecting rib 18, 18′ (in the exemplary embodiment in FIG. 1, the “inner” connecting rib 18′ of the metal part 12) can, for example, form the fitting end stop.

The connecting ribs 18, 18′ and connecting grooves 17, 17′ can in principle have any geometry which is suitable for forming at least one pressure contact 19 in the sealing region 13. For example, a longitudinal extent a₁ of the connecting rib 18, 18′ can be at least 0.3 mm, preferably at least 0.5 mm. A wall thickness a₂ of the connecting rib 18, 18′ can be, for example, at least 0.1 mm, preferably at least 0.2 mm, more preferably at least 0.3 mm. The dimensions of the connecting groove 17, 17′ can correspondingly be designed as complementary. The above-mentioned values are to be understood as purely being examples.

The connecting grooves 17, 17′ and connecting ribs 18, 18′ preferably run in a longitudinal direction, i.e. preferably parallel to the longitudinal axis L of the plug connector 1. The connecting ribs 18, 18′ and/or connecting ribs 17, 17′ can, however, optionally also run tilted relative to the longitudinal axis L of the plug connector 1, as indicated in FIG. 5.

It can furthermore optionally be advantageous if the connecting rib 18, 18′ is widened, starting from its top face 22 and/or if the connecting groove 17, 17′ is widened, starting from its groove base 23, because the insertion force for the fitting can then be specified in a defined fashion.

The above-described invention is in principle suitable for use with any type of plug connector, for which reason the circumstances illustrated in the Figures are to be understood only as examples. In particular, the invention can also be suited for use solely with cable plug connectors, wherein, for example, instead of the electrical module 3 illustrated in FIG. 1, an electrical cable can be attached directly to the first connection interface 7 of the plug connector 1. The plug connector 1 can moreover also be suitable as an adapter plug connector.

1. An electrical plug connector (1) comprising:
a plastic part (11); and
a metal part (12); and wherein
one of the plastic part (11) or the metal part (12) is accommodated at least partially in the other part (12, 11); and wherein
a sealing region (13) is formed between the plastic part (11) and the metal part (12); and wherein
the plastic part (11) and the metal part (12) are connected to each other directly in a force-fitting fashion in the sealing region (13); and wherein
one of the plastic part (11) or the metal part (12) has in the sealing region (13) a connecting groove (17, 17′) which runs around a whole of the periphery of the said part (11, 12) and the said connecting groove (17, 17′) can be accessed in an axial direction (x); and wherein
the other of the plastic part (11), or the metal part (12), has in the sealing region (13) a connecting rib (18, 18′) which runs around a whole of the periphery of the said part (11, 12) and the said connecting rib (18, 18′) is accommodated in the connecting groove (17, 17′); and
when interconnected the connecting groove (17, 17′) and the connecting rib (18, 18′) form at least one pressure contact (19), which runs around the whole of the periphery of the two said parts (11, 12) such that a passage (P) between the plastic part (11) and the metal part (12) is sealed by the at least one pressure contact (19).

2. The electrical plug connector (1) as claimed in claim 1 and wherein one of the plastic part (11) or the metal part (12) has a connecting sequence consisting of one of the connecting grooves (17, 17′) and one of the connecting ribs (18, 18′); and
the one of the plastic part (11) or the metal part (12 that has the connecting sequence is connected to a complementary connecting sequence consisting of one of the connecting ribs (18, 18′) and one of the connecting grooves (17, 17′) of the other part (12, 11).

3. The electrical plug connector (1) as claimed in claim 2 and wherein the connecting groove (17, 17′) transitions directly into the connecting rib (18, 18′) within the connecting sequence.

4. The electrical plug connector (1) as claimed in claim 1 and wherein the at least one pressure contact (19) runs around the whole of the periphery along a line.

5. The electrical plug connector (1) as claimed in claim 1 and further comprising:
a plurality of pressure contacts (19); and
the plurality of pressure contacts (19) are distributed along the passage (P) between the plastic part (11) and the metal part (12).

6. The electrical plug connector (1) as claimed in claim 5 and wherein at least one of the plural pressure contacts (19) is arranged, preferably concentrically, inside a further pressure contact (19) in a lateral direction relative to a longitudinal axis (L) of the plug connector (1).

7. The electrical plug connector (1) as claimed in claim 5 and wherein at least one of the plural pressure contacts (19) is formed between side walls (20) of the connecting grooves (17, 17′), situated directly opposite one another, and side walls (21) of the connecting ribs (18, 18′).

8. The electrical plug connector (1) as claimed in claim 1 and wherein a wall thickness of the connecting rib (18, 18′) is widened, starting from its top face (22).

9. The electrical plug connector (1) as claimed in claim 1 and wherein a top face (22) of the connecting rib (18, 18′) forms an axial fitting end stop between the plastic part (11) and the metal part (12).

10. The electrical plug connector (1) as claimed in claim 1 and wherein a longitudinal extent (a₁) of the connecting rib (18, 18′) is at least 0.3 mm.

11. The electrical plug connector (1) as claimed in claim 1 and wherein the plastic part (11) has a hydrophobic surface and/or material properties that are resistant to hydrolysis and/or the plastic part (11) has a thermal coefficient of expansion which is less than 10·10⁻⁵ 1/K, and/or the plastic part (11) has an elongation at break which is greater than 1%.

12. The electrical plug connector (1) as claimed in claim 1 and wherein the plastic part (11) is formed from hard plastic, preferably from polyketone (PK) or polyether ether ketone (PEEK).

13. The electrical plug connector (1) as claimed in claim 1 and further comprising:
an outer housing (9); and
the plastic part (11) and the metal part (12) are accommodated inside the outer housing (9); and
the plastic part (11) is a contact carrier for accommodating at least one internal conductor contact element (14), and the plastic part (11) is accommodated at least partially in the metal part (12); and
the metal part (12) is an external conductor contact element.

14. A plug connector assembly (2) comprising:
an electrical plug connector (1) having
a plastic part (11), and
a metal part (12), and wherein
one of the plastic part (11) or the metal part (12) is accommodated at least partially in the other part (12, 11), and wherein
a sealing region (13) is formed between the plastic part (11) and the metal part (12), and wherein
the plastic part (11) and the metal part (12) are connected to each other directly in a force-fitting fashion in the sealing region (13), and wherein
one of the plastic part (11) or the metal part (12) has in the sealing region (13) a connecting groove (17, 17′) which runs around a whole of the periphery of the said part (11, 12) and the said connecting groove (17, 17′) can be accessed in an axial direction (x), and wherein
the other of the plastic part (11), or the metal part (12), has in the sealing region (13) a connecting rib (18, 18′) which runs around a whole of the periphery of the said part (11, 12) and the connecting rib (18, 18′) is accommodated in the connecting groove (17, 17′), and
when interconnected, the connecting groove (17, 17′) and the connecting rib (18, 18′) form at least one pressure contact (19), which runs around the whole of the periphery of the two said parts (11, 12) such that a passage (P) between the plastic part (11) and the metal part (12) is fluid-tightly sealed by the pressure contact (19); and
an electrical module (3) or an electrical cable, connected to the electrical plug connector (1).

15. The plug connector assembly (2) as claimed in claim 14, and wherein the electrical module (3) has a module housing (6), and the module housing (6) has an end portion that defines a housing opening leading to an interior (6′), for connection to the electrical plug connector (1); and wherein
the sealing region (13) is between the end portion, facing the interior (6′) of the module housing (6), of the plastic part (11) and the metal part (12).

1. The electrical plug connector (1) as claimed in claim 1 and wherein the pressure contact seal formed by the interconnected plastic part (11) and the metal part (12) is fluid-tight.

17. The electrical plug connector (1) as claimed in claim 1 and wherein the pressure contact (19) runs around the whole of the periphery over a plane surface.

18. The electrical plug connector (1) as claimed in claim 1 and wherein a width of the connecting groove (17, 17′) is widened, starting from its groove base (23).

19. The electrical plug connector (1) as claimed in claim 1 and wherein a wall thickness (a₂ ) of the connecting rib (18, 18′) is at least 0.1 mm.
